(19) United States
(12) Patent Application Publication
(10) Pub. No.: US 2001/0051252 A1
(43) Pub. Date: Dec. 13, 2001

(54) Moisture and weather proofing membrane and process therefor

(76) Inventors: Richard Voyer, St-Charles-de-Drummond (CA); William Tarapaski, Burnaby (CA)

Correspondence Address: ST. ONGE STEWARD JOHNSTON & REENS, LLC, 986 BEDFORD STREET, STAMFORD, CT, 06905-5619, US

(21) Appl. No.: 09/836,090

(22) Filed: Apr. 17, 2001

(30) Foreign Application Priority Data
May 30, 2000 (CA) 2,310,297

(51) Int. Cl. B32B 1/00; D06N 7/04; B32B 3/10; B32B 3/00; B32B 27/14

(52) U.S. Cl. 428/131; 428/143; 428/150; 428/195

(57) ABSTRACT

A moisture and weather proofing membrane is disclosed, comprising a carrier layer having opposite top and under faces. A waterproof layer made of a waterproof material, preferably bitumen, is coating the top face of the carrier layer; and spaced self-adhesive bituminous pieces are bonded to the under face of the carrier layer, leaving therebetween interconnected spaces of uncoated carrier layer. The interconnected spaces act as bond breakers and thereby allow the diffusion of vapor pressure formed underneath the membrane once installed on a roof. A method for manufacturing such a membrane is also disclosed.

### FIELD OF THE INVENTION

The present invention generally relates to protective membranes used in the construction of buildings. More particularly, it relates to a roofing, moisture proofing and weather proofing membrane and to the manufacturing process of such membrane.

### BACKGROUND OF THE INVENTION

Moisture and weather proofing membranes are commonly used in the construction field, mainly to protect the roofs from water leaks, which cause problems of moisture. These membranes are typically manufactured using fibrous web coated with a weather resistant bituminous coating material.

Already known in the prior art, there is a bitumen membrane comprising a carrier layer made of glass fiber sandwiched between two layers of bitumen. The membrane is installed on the roof and a finish covering is installed thereon. As well known in the art, the infiltration of water may come from the outside, or the inside, of the building in the form of vapour. A drawback encountered with such a prior art membrane is that, even though it may prevent an infiltration of water from the outside, it also prevents the water and air from the inside to escape from the roof, thereby causing a vapour pressure underneath the membrane. This problem of underneath infiltration of air and humidity is well discussed in U.S. Pat. No. 4,992,315, where it is mentioned that moisture vapour from different sources can cause formation of bubbles and subsequent leaks in the bituminous waterproofing layer, especially on hot days when the water vapour is caused to expand due to the heat. There is a bituminous roofing membrane known in the prior art that reduces in some way the effect of that problem of underneath vapour pressure. That membrane is a laminated membrane comprising a reinforcement layer sandwiched between two layers of bitumen. The membrane further comprises a layer of sand covering one of the bituminous layers and strips of self-adhesive bitumen added on the layer of sand. The vapour pressure from underneath the membrane can escape therefrom by diffusion between the strips of self-adhesive bitumen. This prior art membrane however shows some drawbacks. For example, one of the problems is that when the temperature gets very high, the bitumen of the bituminous layer eventually runs through the layer of sand and the membrane becomes fully adhered to the substrate and loses its performance.

Other examples of roofing membranes are shown in Canadian patent application no. 2,022,442; Canadian patent no. 1,124,143; U.S. Des. Pat. No. 297,465; U.S. Pat. Nos. 3,890,263; 4,342,804; 4,343,847; 4,481,245; 4,659,759; 4,983,426; 4,992,315; 5,055,135; 5,110,674; 5,143,766; 5,182,319; 5,311,716; 5,437,923; 5,439,726; 5,695,373; 5,787,668; 5,843,522; 5,848,510; 5,865,549; and 6,044,604.

### SUMMARY OF THE INVENTION

An object of the present invention is to propose an improved moisture and weather proofing membrane, and a process for manufacturing the same.

Another object of the present invention is to provide a roofing membrane that allows air and humidity trapped thereunder to easily escape without damaging the membrane.

In accordance with that object, the present invention proposes a moisture and weather proofing membrane comprising a carrier layer having opposite top and under faces, a waterproof layer made of a waterproof material coating the top face of the carrier layer; and spaced self-adhesive bituminous pieces bonded to the under face of the carrier layer. The bituminous pieces are saturating at least in part the carrier layer. The membrane further comprises interconnected spaces of uncoated carrier layer between the self-adhesive bituminous pieces.

According to a preferred feature, each of the bituminous pieces adheres to the waterproof material of the waterproof layer. Also preferably, the waterproof material of the waterproof layer saturates the carrier layer partially.

As can be appreciated, these interconnected spaces of uncoated carrier layer act as bond breakers, and thereby allow the diffusion of vapour pressure formed underneath the membrane once installed on a substrate. Also, thanks to the fact that the self-adhesive bituminous pieces saturate the carrier layer, meaning that they penetrate or impregnate the carrier layer, no vapour or water can seep between those pieces and the carrier layer.

The bituminous pieces preferably consist of broken bituminous strips extending substantially in parallel to each other.

The present invention also proposes a process for making a membrane as described above which comprises the steps of:

a) providing a sheet of carrier material;

b) coating a top face of said sheet with a waterproof material; and

c) applying on the under face of the sheet, pieces of self-adhesive bitumen saturating at least in part the carrier material.

Preferably, in step c) the pieces of self-adhesive bitumen are adhering to the waterproof material of the top face. Also preferably, in step a), the waterproof material is saturating partially the carrier material.

### BRIEF DESCRIPTION OF THE DRAWINGS

FIG. 1 is a bottom view of a membrane according to a preferred embodiment of the present invention showing the underside of that membrane.

FIG. 2 is a cross-sectional side view of the membrane shown in FIG. 1 along line II-II.

FIG. 3 is a schematic view showing a process for making a membrane according to the present invention.

FIG. 4 is a perspective view of a roller used for applying the strips of self-adhesive bitumen on the underside of the membrane.

### DESCRIPTION OF A PREFERRED EMBODIMENT

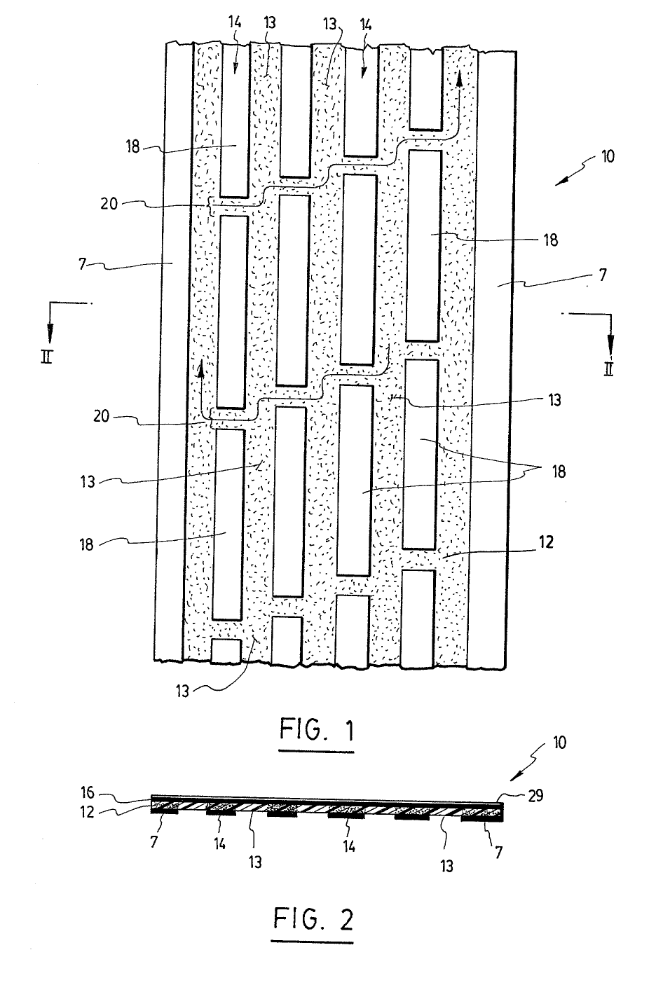

Referring to FIGS. 1 and 2, a roofing, moisture proofing and weatherproofing membrane (10) according to a preferred embodiment of the invention is illustrated. The membrane (10) can be installed on a substrate, such as a roof, to protect the same from water infiltration or other bad weather such as freezing and thawing, humidity, etc. The membrane (10) is composed of a carrier layer (12) that acts as a reinforcement layer. The carrier layer (12) has a top face coated with a waterproof material (16). The carrier layer (12) is preferably made of a sheet of glass fiber but any other material commonly used in the prior art as the reinforcement layer can be used.

A plurality of spaced self-adhesive bituminous pieces (14) are applied and bonded to the under face of the carrier layer (12), leaving therebetween interconnected spaces (13) of uncoated carrier layer. The pieces (14) of self-adhesive bitumen allow the membrane (10) to be fixed by bonding to the substrate, whereas these interconnected spaces (13) of uncoated carrier layer act as bond breakers and thereby allow the diffusion of vapour pressure formed underneath the membrane once it is installed on a substrate. The arrows on FIG. 1 show an example of a path that can be followed by the vapour to escape from underneath the membrane (10). According to a preferred embodiment which provides a better attachment and which better prevents the vapour or water from seeping between the bituminous pieces (14) and the carrier layer (12), the bituminous pieces (14) and the density of the carrier layer (12) are chosen so that during application of the bituminous pieces (14), the bitumen saturates the carrier layer (12) and adheres to the waterproof material (16) coating the top face.

More preferably, the carrier layer (12) is made of fiberglass having a fiber density greater than about 100 g/cm³ and less than about 150 g/cm³, more or less 5 g/cm³. Most preferably, the fiber density is about 130 g/cm³.

A finishing layer such as a thermoplastic film (29) is preferably covering the waterproof layer (16) and that, especially if the waterproof material is sticky. The finishing layer could also be made of any material selected from the group consisting of a thermoplastic film, sand, talc, and granules.

The membrane (10) is a semi-adhered self-adhesive sheet that can be used over all substrates such as a roof. Since the membrane (10) adheres only partially to the substrate, it can be installed directly on insulation boards without an intermediate board.

According to the preferred embodiment illustrated, the bituminous pieces (14) are broken bituminous strips (14) extending in parallel to each other along a longitudinal direction of the membrane (10). Also preferably, each broken bituminous strip (14) consists of a plurality of longitudinally aligned bands (18) separated by gaps (20) of uncoated carrier layer (12). The gaps (20) of each strip is in a non aligned relationship with the gaps (20) of an adjacent strip so to provide a better path for the escaping vapour.

It should be understood that another embodiment of the invention, not illustrated, may advantageously have an infinite number and width of self-adhesive bituminous pieces having another shape than the one illustrated, as long as these pieces allow the membrane to be bonded to the substrate and the formation of the bond breaker consisting of an uncoated carrier layer. Other examples of shapes that can be used could be circular, triangular, elliptical, etc.

The waterproof layer (16) is preferably made of a material selected from the group consisting of bitumen, bitumen modified with a polymer selected from the group consisting of SBS, SIS,SB, SEBS and APP, and oxidized asphalt. Most preferably, it is a modified bitumen. It is also preferably chosen so that it can saturate partially the carrier layer during the application of the waterproof layer (16) so to better adhere with the bitumen of the bituminous stripes (14) saturating also the carrier layer (12). The bituminous self-adhered pieces (14) saturate, that is to say penetrate, the carrier layer (12) and thus prevent the vapor and water from seeping between these pieces (14) and the carrier layer (12). The membrane (10) is unique in that it uses an unsaturated portion of the carrier (12) as the bond breaker. By doing this, the diffusion of vapour pressure is superior and also the possibility of bonding at a future date is virtually eliminated.

The membrane (10) can be offered in any thickness, and in a variety of finishes on the top surface, such as a film, sand, talc or granules. A variety of finishes on the under side could be used, such as a siliconised release film, thermofusible plastic film or any other surfacing suitable for installation.

The bitumen can be modified with any polymer such as: SBS, SIS, SB, SEBS, APP, etc. Oxidized asphalt or any product suitable for waterproofing could also be used. The reinforcement layer is preferably a sheet of glass fibre, but could also be any other material commonly used in the prior art as reinforcement.

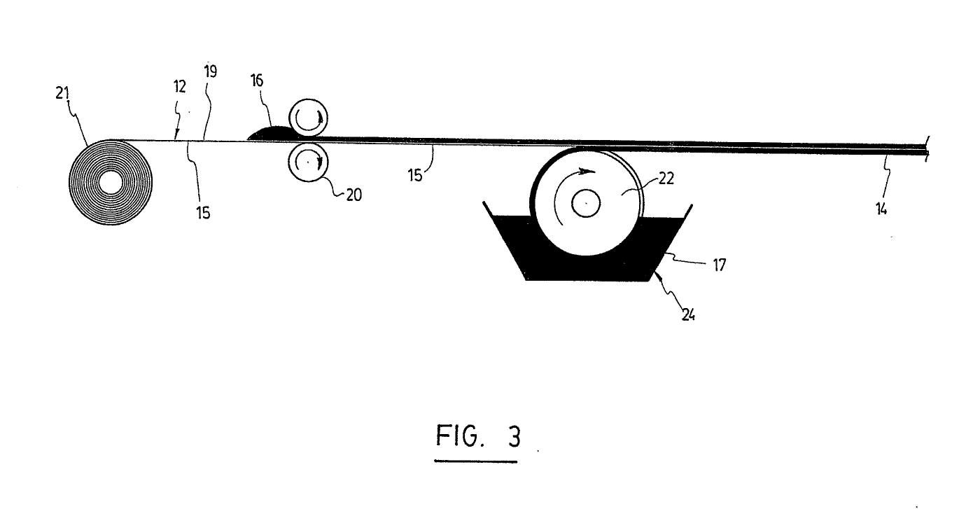

Referring to FIG. 3, a preferred version of a process according to the invention is schematically illustrated. As can be appreciated, the process comprises the steps of: a) providing a sheet (12) of carrier material; b) coating the top face (19) of the sheet (12) with a waterproof material (16), preferably modified bitumen; and c) applying on the under face (15) of the sheet (12) strips (14) of self-adhesive bitumen (17). More particularly, a roll (21) of carrier material is unrolled, and soft or liquefied modified bitumen (16) is applied on the top face (19). The sheet (12) with the soft bitumen (16) thereon is passed through press rollers (20) to spread the bitumen and saturate the carrier material partially.

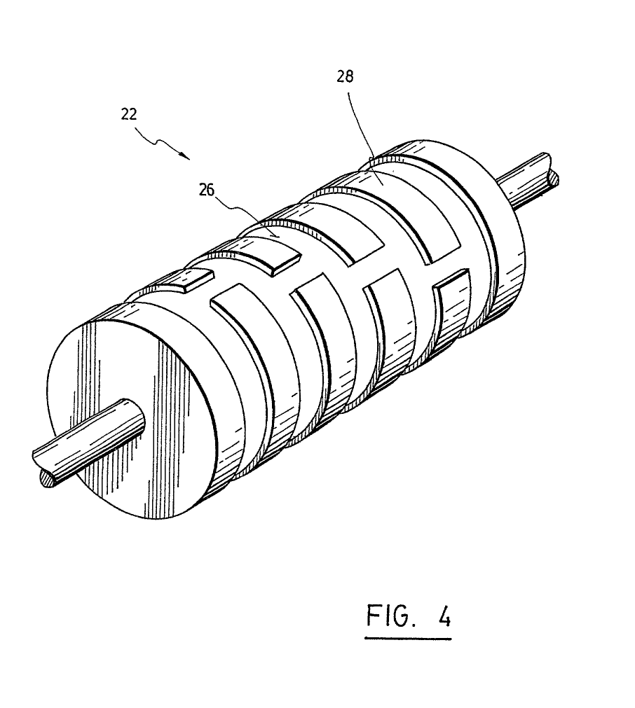

The strips of self-adhesive bitumen are applied on the under face (15) of the sheet (12) by bringing the same into contact with the surface of a roller (22) soaking in a pool (24) containing liquefied self-adhesive bitumen (17). The surface of the roller (22) has a given relief that allows the self-adhesive bitumen to be applied on the under face (15) of the sheet (12), as broken strips. More specifically, as shown in FIG. 4, the roller (22) has a surface (26) including a plurality of elongated bands (28) projecting from the surface (26). The roller (22) is thus soaked and rolled in the pool (24) such that a portion of the roller (22) is coming out from the liquid, as shown in FIG. 3. The sheet (12) is passed over the roller (22) and the under face thereof is brought in contact with the portion of the roller (22) coming out of the liquid, thereby applying thereon broken strips of self-adhesive bitumen which saturate, in other words penetrate, the carrier material and adhere to the waterproof material (16) coating the top face.

The method preferably comprises the additional step of d) covering the waterproof material (16) with a finishing layer.

The waterproof material used to cover the top face is preferably selected from the group consisting of bitumen, bitumen modified with a polymer selected from the group consisting of SBS, SIS, SB, SEBS and APP and oxidized asphalt, and the carrier material is preferably fiber glass, but could also be any material commonly used in the prior art as reinforcement.

Although a preferred embodiment of the present invention has been described in detail herein and illustrated in the accompanying drawings, it is to be understood that the invention is not limited to this precise embodiment and that various changes and modifications may be effected therein without departing from the scope or spirit of the present invention.

What is claimed:

1. A moisture and weather proofing membrane comprising:
a carrier layer having opposite top and under faces;
a waterproof layer made of a waterproof material coating the top face of the carrier layer; and
spaced self-adhesive bituminous pieces bonded to the under face of the carrier layer, said bituminous pieces saturating at least in part the carrier layer; and
interconnected spaces of uncoated carrier layer between the self-adhesive bituminous pieces.

2. A moisture and weather proofing membrane according to claim 1, wherein each of the bituminous pieces adheres to the waterproof material of the waterproof layer.

3. A moisture and weather proofing membrane according to claim 2, wherein the waterproof material of the waterproof layer saturates partially the carrier layer.

4. A moisture and weather proofing membrane according to claim 1, wherein:
said bituminous pieces consist of broken bituminous strips extending substantially in parallel to each other.

5. A moisture and weather proofing membrane according to claim 4, wherein the membrane has a longitudinal direction and the bituminous strips extend longitudinally thereon.

6. A moisture and weather proofing membrane according to claim 5, wherein:
each broken bituminous strip consists of a plurality of longitudinally aligned bands separated by gaps of uncoated carrier layer, the gaps of each strip being in a non aligned relationship with the gaps of an adjacent strip.

7. A moisture and weather proofing membrane according to claim 1, comprising:
a finishing layer covering the waterproof layer.

8. A moisture and weather proofing membrane according to claim 7, wherein the finishing layer is made of a material selected from the group consisting of a thermoplastic film, sand, talc, and granules.

9. A moisture and weather proofing membrane according to claim 1, wherein:
the waterproof layer is made of a material selected from the group consisting of bitumen, bitumen modified with a polymer selected from the group consisting of SBS, SIS, SB,SEBS and APP, and oxidized asphalt.

10. A moisture and weather proofing membrane according to claim 1, wherein the carrier layer is a sheet of glass fiber.

11. A moisture and weather proofing membrane according to claim 10, wherein the sheet of fiber glass has a fiber density greater than 100 g/cm³ and less than 150 g/cm³.

12. A moisture and weather proofing membrane according to claim 11, wherein the fiber density is about 130 g/cm³.

13. A method for making a moisture and weather proofing membrane comprising the steps of:
a) providing a sheet of carrier material;
b) coating a top face of said sheet with a waterproof material; and
c) applying on an under face of the sheet, pieces of self-adhesive bitumen saturating at least in part the carrier material.

14. A method for making a moisture and weather proofing membrane according to claim 13, wherein in step c), the pieces of self-adhesive bitumen are adhering to the waterproof material of the top face.

15. A method for making a moisture and weather proofing membrane according to claim 14, wherein in step a), the waterproof material is saturating the carrier material partially.

16. A method for making a moisture and weather proofing membrane according to claim 13, comprising the additional step of:
d) covering the waterproof material with a finishing layer.

17. A method for making a moisture and weather proofing membrane according to claim 13, wherein step a) comprises the step of:
unrolling a roll of said sheet of carrier material.

18. A method for making a moisture and weather proofing membrane according to claim 17, wherein step b) comprises:
softening the waterproof material;
applying the softened waterproof material on the top face of said sheet of carrier material; and
passing the sheet of carrier material with the softened waterproof material thereon through press rollers to spread the waterproof material.

19. A method for making a moisture and weather proofing membrane according to claim 18, wherein step c) comprises the steps of:
providing a roller having a surface including a plurality of elongated bands projecting from the surface;
soaking and rolling said roller in a pool containing said self-adhesive bitumen in a substantially liquid state such that a portion of the roller is coming out from the liquid; and
passing the sheet of carrier material over said roller and bringing the under face thereof in contact with said portion of the roller.

20. A method for making a moisture and weather proofing membrane according to claim 19, wherein the waterproof material is selected from the group consisting of bitumen, bitumen modified with a polymer selected from the group consisting of SBS, SIS, SB, SEBS and APP, and oxidized asphalt.

21. A method for making a moisture and weather proofing membrane according to claim 14, wherein the carrier material is fiberglass.
